(19) United States
(12) Patent Application Publication
(10) Pub. No.: US 2018/0237247 A1
(43) Pub. Date: Aug. 23, 2018

(54) LIQUID ABSORBENT SOCK AND METHOD OF MANUFACTURE THEREOF

(71) Applicant: CAN-ROSS ENVIRONMENTAL SERVICES LTD., Oakville (CA)

(72) Inventor: Carlo FASCIO, Kleinberg (CA)

(21) Appl. No.: 15/467,621

(22) Filed: Mar. 23, 2017

(30) Foreign Application Priority Data
Feb. 22, 2017 (CA) 2958663

(51) Int. Cl. B65H 18/28; B01J 20/26; B01J 20/28; B01J 20/30; C09K 3/32

(52) U.S. Cl. CPC B65H 18/28; B01J 20/26; B65H 2701/121; B01J 20/3092; C09K 3/32; B01J 20/2805

(57) ABSTRACT

A roll of absorbent socks is provided with a liquid permeable sleeve that houses an absorbent layer with a superabsorbent polymer. Perforated regions are provided spaced apart along the length of the sleeve with a plurality of perforations through the sleeve and the absorbent layer. The perforations define the end of a first sock and the adjacent end of a second sock. Mechanical closure members are provided on opposed sides of and adjacent to each perforated region. When a sock is separated from the role, it has first and second longitudinally spaced apart ends that are closed by the mechanical closure members to prevent superabsorbent polymer from flowing out the ends of the sock.

### CROSS REFERENCE TO RELATED APPLICATIONS

This application claims priority under 35 U.S.C. 119 to Canadian Patent Application Ser. No. 2,958,663, filed Feb. 22, 2017, entitled LIQUID ABSORBENT SOCK AND METHOD OF MANUFACTURE THEREOF, which is incorporated herein in its entirety by reference.

### FIELD

This specification relates to liquid absorbent socks and a method for manufacturing liquid absorbent socks. In particular embodiments, the specification relates to absorbent socks with mechanical closure members.

### INTRODUCTION

The following is not an admission that anything discussed below is part of the prior art or part of the common general knowledge of a person skilled in the art.

Liquid absorbent socks or strips are known. For example, CA 2,841,469 discloses liquid control strips with a non-woven sleeve and one or more substrate layers within the sleeve. The substrate layer is impregnated with a super absorbent polymer. The sleeve and substrate are perforated at periodic lengths to permit the selection of a desired length of the liquid control strip.

The liquid control strips disclosed in CA 2,841,469 have a slurry of starch and salt applied on the substrate layer prior to insertion of the substrate layer into the sleeve. The slurry de-activates the superabsorbent polymer. The slurry is applied to the substrate on either side of locations where perforations are expected to be to de-activate the super-absorbent polymer in areas adjacent the perforations.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

According to one broad aspect, there is a provided a roll of absorbent socks wherein one end, and preferably both ends, of a portion of the roll that may be separated to define an absorbent sock are closed by mechanical closure members. For example, the ends may be stitched closed. It has surprisingly been found that using a plurality of mechanical closure members that are spaced apart inhibits or essentially inhibits the flow of hydrated superabsorbent polymer out the ends of the sock.

In accordance with this embodiment, there is provided a roll of absorbent socks, the roll comprising:

longitudinally extending liquid permeable sleeve having a length and a width;

at least one absorbent layer comprising a superabsorbent polymer housed within the sleeve;

a plurality of perforated regions spaced apart along the length of the sleeve, each perforated region extending across the width of the sleeve, each perforated region comprising a plurality of perforations through the sleeve and the at least one absorbent layer; and,

a first plurality of mechanical closure members and a second plurality of mechanical closure members longitudinally spaced apart from the first plurality of mechanical closure members and on opposed sides of and adjacent a perforated region, each plurality of mechanical closure members are provided generally across the width of the sleeve,

wherein a portion of the sleeve extending between sequential perforated regions defines a sock,

whereby, once separated along the perforated regions, each sock has a first and second longitudinally spaced apart ends that are closed by the mechanical closure members

In some embodiments, the plurality of mechanical closure members may include stitches.

In some embodiments, each plurality of mechanical closure members may include rows of stitches extending generally across the width of the sleeve.

In some embodiments, a portion of the sleeve which defines a sock may extend continuously longitudinally from a first end of the sock to a second end of the sock.

In some embodiments, at least some of the mechanical closure members provided at the first end of the sock may be spaced inward from the first end of the sock and at least some of the mechanical closure members provided at the second end of the sock may be spaced inward from the second end of the sock.

In some embodiments, the stitches may extend in a direction of the width.

In some embodiments, the mechanical closure members may extend through the at least one absorbent layer.

In some embodiments, the mechanical closure members may extend through the at least one absorbent layer and the superabsorbent polymer extends to the first end of the sock and the second end of the sock.

In some embodiments, once the superabsorbent polymer is hydrated, the stitches may be configured to at least substantially prevent the flow of superabsorbent polymer out of the ends of the sock.

In accordance with this aspect, there is also provided an absorbent sock comprising:

a longitudinally extending liquid permeable sleeve having a first end, a longitudinally spaced apart second end and a width, each end comprising an upper sleeve portion and a lower sleeve portion; and,

at least one absorbent layer comprising a superabsorbent polymer housed within the sleeve,

wherein, at each end, the upper sleeve portion and the lower sleeve portion are secured to each other by a plurality of mechanical closure members that extend through the sleeve between the upper and lower sleeve portions

In some embodiments, the mechanical closure members may comprise stitches.

In some embodiments, the mechanical closure members may comprise rows of stitches extending generally across the width of the sleeve.

In some embodiments, the sleeve may extend continuously longitudinally from the first end to the second end.

In some embodiments, at least some of the mechanical closure members provided at the first end may be spaced inward from the first end and at least some of the mechanical closure members provided at the second end may be spaced inward from the second end.

In some embodiments, the stitches may extend in a direction of the width.

In some embodiments, the mechanical closure members may extend through the at least one absorbent layer.

In some embodiments, the superabsorbent polymer may extend to the first end and the second end.

In some embodiments, once the superabsorbent polymer is hydrated, the stitches may be configured to at least substantially prevent the flow of superabsorbent polymer out of the ends of the sock.

In accordance with this aspect, there is also provided a method of manufacturing a roll of absorbent socks, the method comprising:

providing a longitudinally extending tube of liquid permeable material having a super absorbent polymer provided along the length of an interior of the tube;

providing a plurality of mechanical closure members at locations of the tube defining an end of a first absorbent sock and an adjacent end of a second absorbent sock;

providing a plurality of perforations across a width of the tube to define the end of the first sock and the adjacent end of the second sock.

In some embodiments, providing a plurality of mechanical closure members may include inserting stitches across the width of the tube at one location defining the end of the first absorbent sock and inserting stitches across the width of the tube at a second longitudinally spaced apart location defining the adjacent end of the second absorbent sock.

In some embodiments, providing a plurality of mechanical closure members may include inserting a plurality of longitudinally spaced apart rows of stitches across the width of the tube to define a closure region whereby the plurality of perforations are provided across the closure region.

In some embodiments, once the superabsorbent polymer is hydrated, the stitches may be configured to at least substantially prevent the flow of superabsorbent polymer out of the ends of the sock.

It will be appreciated by a person skilled in the art that an absorbent sock, a roll of absorbent socks and/or a method of manufacturing a roll of absorbent socks may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a top view of an example embodiment of a roll of absorbent socks;

FIG. 2 is a top view of an example embodiment of an absorbent sock;

FIG. 3 is cross-section view along the line a-a in FIG. 2.

FIG. 4 is a top view of an example embodiment of a portion of a roll of absorbent socks with mechanical closure members;

FIG. 5 is a top view of the portion of the roll of absorbent socks of FIG. 4 with perforations; and,

FIG. 6 is a partial schematic view of a process for manufacturing absorbent socks in accordance with an example embodiment.

The drawings included herewith are for illustrating various examples of articles, methods, and apparatuses of the teaching of the present specification and are not intended to limit the scope of what is taught in any way.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising,” and variations thereof mean “including but not limited to,” unless expressly specified otherwise. A listing of items does not imply that any or all of the items are mutually exclusive, unless expressly specified otherwise. The terms “a,” “an,” and “the” mean “one or more,” unless expressly specified otherwise.

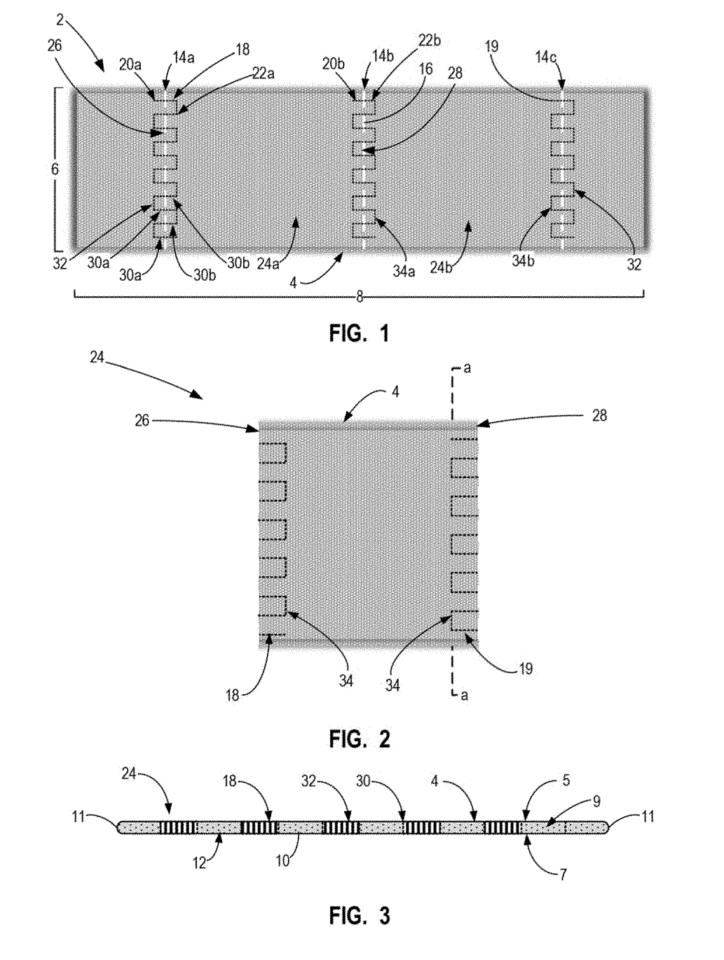

Referring to FIGS. 1-5, an example embodiment of a roll 2 of liquid absorbent socks 24 is shown. A roll 2 of liquid absorbent socks 24 generally includes a plurality of absorbent socks 24. Individual absorbent socks 24 may be detached or separated from the roll 2 for use. Alternatively, multiple absorbent socks 24 may be detached as a unit, or the socks 24 may remain attached in roll 2 and deployed collectively for use.

Liquid absorbent socks 24 can be used in various applications to absorb liquid and/or prevent the flow of liquids. Liquid absorbent socks 24 can be used to contain liquids from leaks or spills, for example by at least partially absorbing and retaining the spilled liquid. Liquid absorbent socks 24 may also be used to provide a barrier to prevent liquids from escaping a certain area, such as a desired area of application.

In the example illustrated, the roll 2 has a sleeve 4 that extends longitudinally in a length direction 8. The sleeve 4 defines an outer surface of the socks 24. The sleeve 4 extends continuously longitudinally in the length direction 8.

The sleeve 4 is formed by a longitudinally extending tube. The longitudinally extending tube may have a substantially hollow interior prior to being formed into absorbent socks 24. The interior of the sleeve 4 defines an inner region 9 within which one or more absorbent layers 10 are housed. The absorbent layer(s) 10 may also extend substantially continuously within the sleeve 4 in the longitudinal length direction 8. The size of the tube used for sleeve 4 (e.g., the width 6 of the tube) may be adjusted, for example, based on a desired size of the absorbent layer(s) 10.

As exemplified in FIG. 3, the sleeve 4 has an upper sleeve portion 5 that is spaced apart from a lower sleeve portion 7 and sides 11 that extend between the upper sleeve portion 5 and the lower sleeve portion 7. The upper sleeve portion 5 and lower sleeve portion 7 extend across the width 6 of the sleeve 4. The inner region 9 of the sleeve 4 is defined between the upper sleeve portion 5, the lower sleeve portion 7 and sides 11.

The tube is formed using a liquid permeable material to provide a liquid permeable sleeve 4. This allows liquid to pass through the sleeve 4 and be absorbed by the inner absorbent layer(s) 10. Any liquid permeable material which retains its strength when wet may be used to manufacture sleeve 4. For example, non-woven materials such as polypropylene or polyethylene may be used for the sleeve 4.

The sleeve 4 may be formed using any means known in the art. For example, the sleeve 4 may be formed by wrapping a length of liquid permeable material into a substantially tubular shape along its longitudinal length 8. The edges of the wrapped tube may then be secured to each other, e.g., fused using sonic welding, to provide the sleeve 4. Alternatively, multiple discrete sections of material may be joined (e.g., fused) together to form sleeve 4.

In some cases, the sides 11 of the sleeve 4 may be formed with pleats (not shown). The pleats may be movable between folded and unfolded configurations as the absorbent sock 24 absorbs liquid and expands. The pleats may allow the sleeve 4 to lie substantially flat in a storage position and expand to an in-use position with the pleats unfolded as liquid is absorbed.

The absorbent layer(s) 10 includes one or more superabsorbent polymer 12. The absorbent layer(s) 10 may comprise a substrate layer that is impregnated or otherwise provided or seeded with the superabsorbent polymer. Alternatively, the superabsorbent polymer may simply be disposed within the inner region 9 of sleeve 4.

As exemplified, the sleeve 4 provides a physical barrier on the upper sleeve portion 5, the lower sleeve portion 7 and sides 11 to retain the superabsorbent polymer 12 within the inner region 9. The material used to form sleeve 4 may substantially or completely prevent the flow of superabsorbent polymers 12 therethrough.

Superabsorbent polymer 12 generally refers to absorbent polymers that absorb and retain extremely large amounts of liquid relative to their own mass. As superabsorbent polymers 12 absorb liquid, they swell and expand in size. Various superabsorbent materials may be used for the superabsorbent polymer 12, such as one or more of sodium polyacrylate, polyacrylamide copolymer, starch grafted copolymer of polyacrylonitrile and the like.

As exemplified in FIG. 1, perforated regions 14 are spaced apart long the length of the sleeve 4. Each perforated region 14 extends across or substantially across the width 6 of sleeve 4. Each perforated region 14 includes a plurality of perforations 16 through the sleeve 4. The perforated regions 14 also pass through any absorbent layer(s) 10 housed within the sleeve 4 at the perforated locations.

The perforated regions 14 define portions of the roll that may be separated to provide individual absorbent socks 24. A portion of the sleeve 4 (and the absorbent layer(s) 10 housed therein) that extends between sequential perforated regions 14 may be separated from the rest of the roll to provide a single individual absorbent sock 24. It will be appreciated that perforated regions 14 may be provided at discrete locations continuously from a first end of the roll to a second end of the roll.

It will be appreciated that, once separated from a roll, the portion of the sleeve 4 that defines a sock 24 extends longitudinally continuously from a first end 26 of the sock 24 to a second end 28 of the sock 24. In some examples, the absorbent layer(s) 10 may also extend longitudinally continuously from the first end 26 to the second end 28 of the sock 24.

The perforated regions 14 allow the absorbent socks 24 to be selectively detached or separated from the roll 2. A user may detach a sock 24 by, e.g., tearing or cutting along the perforated regions 14 at the first end 26 and second end 28 of the sock 24. Multiple socks 24 may be detached as a continuous absorbent sock by, e.g., tearing or cutting along perforated regions defining the ends of the desired length of an absorbent sock. This allows a user to remove an absorbent sock 24 of varying length for use in controlling a liquid spill.

FIG. 2 shows an example of an individual absorbent sock 24. The absorbent sock 24 is an example of a liquid absorbent sock such as may be detached from roll 2 shown in FIG. 1. Alternatively, absorbent socks 24 such as those shown in FIG. 2 may be manufactured/or distributed individually. For example, individual absorbent socks 24 or a series of socks 24 which are removed as a unit from a roll herein may be used as absorbent pads.

Closure regions 21 are located on either side of each perforated region 14. The closure regions 21 operate to close the ends 26/28 of the socks 24 such that, when a sock is removed from a roll and exposed to, e.g., water, the superabsorbent polymer is inhibited from flow out of ends 26/28.

Mechanical closure members 18 are provided in the closure regions 21 adjacent to each perforated regions 14. In general, the mechanical closure members 18 are physical members that secure the upper sleeve portion 5 and lower sleeve portion 7 together. The mechanical closure members 18 can extend between the upper sleeve portion 5 and lower sleeve portion 7. The mechanical closure members 18 can also extend through the absorbent layer(s) 10. The mechanical closure members 18 can be positioned across all or substantially all of the width 6 of the sleeve 4.

The closure region 21 may include a first plurality 20 of mechanical closure members 18 provided on a first side of a perforated region 14. The closure region 21 may also include a second plurality 22 of mechanical closure members 18 provided longitudinally spaced apart from the first plurality 20 of mechanical closure members 18 and on the opposed side of the perforated region 14. As discussed subsequently herein, the plurality of closure members 20, 22 may each be discretely formed on either side of a perforated region 14 or the plurality of closure members 20, 22 may be formed as a single continuous area of closure members 18 and perforated region 14 may be provided in the centre thereof.

Both the first plurality 20 and second plurality 22 of mechanical closure members 18 can be provided across all or substantially all of the width 6 of the sleeve 4. Thus, the first plurality 20 and second plurality 22 of mechanical closure members 18 are configured to close the ends 26/28 of adjacent socks 24 substantially across the width 6 of the sleeve 4.

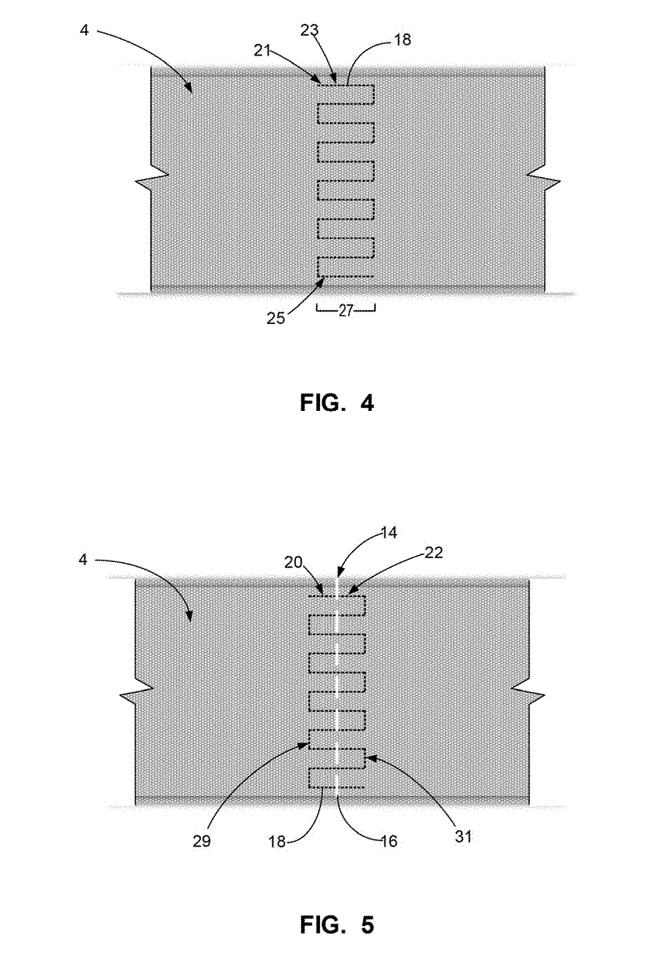

In embodiments where the sides 9 of the sleeve 4 include a pleat, the mechanical closure members 18 may not extend through the pleated region. This can prevent interference with folding and unfolding of the pleat. Accordingly, as exemplified in FIG. 4, the mechanical closure members 18 may be provided generally across the width 6 of the sleeve 4 with the ends 23/25 of the closure regions 21 spaced inwardly from the pleated region. In alternate embodiments, it will be appreciated that mechanical closure members may extend across part or all of the pleated regions.

The first plurality 20 and second plurality 22 of mechanical closure members 18 in a closure region 21 may be provided on opposed sides of and adjacent to a perforated region 14. Once a sock 24 is separated from the roll 2 along the perforated region 14, the detached sock 24 has a first end 26 and a second end 28 that are longitudinally spaced apart. Each of the first end 26 and second 28 is closed by mechanical closure members 18.

In the example illustrated in FIG. 1, sock 24a can be separated from the roll 2 along perforated regions 14a and 14b. When separated, the first end 26 of sock 24a is closed by the second plurality 22a of mechanical closure members 18 that was adjacent perforated region 14a while the second end 28 of sock 24a is closed by the first plurality 20b of mechanical closure members 18 that was adjacent perforated region 14b.

The first plurality 20 and second plurality 22 of mechanical closure members 18 on opposed sides of the same perforated region 14 define the extent of the closure region 21. The mechanical closure members 18 in a closure region 21 can be formed as a continuous section of mechanical closure members 18. This may facilitate manufacturing by allowing the first plurality 20 and second plurality 22 of mechanical closure members 18 to be applied concurrently.

The closure region 21 and perforated regions 14 can be aligned during manufacturing. The closure region 21 may be aligned such that the perforated region 14 is formed between the spaced apart longitudinal ends 29, 31 of the closure region 21 (See FIG. 5). Thus, the perforated region 14 can separate the mechanical closure members 18 into a first plurality 20 and second plurality 22 of mechanical closure members 18. This will also ensure that the ends of adjacent socks 24 are closed when separated from the roll 2 and from one another along the perforated regions.

For example, the mechanical closure members 18 may be applied through the sleeve 4 and absorbent layer(s) 10 initially to define a closure region 21. Subsequently, perforations 19 may be applied through the sleeve and absorbent layer(s) 10 in alignment with the closure region 21 to separate the mechanical closure members 18 into a first plurality 20 and second plurality 22.

The mechanical closure members 18 can include longitudinally extending sections or longitudinal rows 30 of closure members 18. The longitudinally extending sections 30 include a series of mechanical closure members 18 extending in the direction of the length 8 of the sleeve 4. The mechanical closure members 18 also can include laterally extending sections or lateral rows 32 of closure members 18. The laterally extending sections 32 include a series of mechanical closure members 18 extending in the direction of the width 6 of the sleeve 4.

The longitudinally extending sections 30 may define a longitudinal length 27 of the closure region 21. The longitudinal length 27 of the closure region 21 can be configured to be wider than the perforated region 14, to ensure that the first plurality 20 and second plurality 22 of closure members 18 in a closure region 21 are provided on opposing sides of the perforated region 14. The longitudinal length 27 of the closure region 21 may be substantially wider than the perforated region 14 (e.g., 5-10 times) to provide additional tolerance in aligning the closure region 21 and perforated region 14 during manufacturing.

The mechanical closure members 18 in a closure region 21 may be formed into closure patterns that traverse the perforated regions 14. This may facilitate manufacturing by allowing the closure members 18 that are part of the first plurality 20 and second plurality 22 to be applied together in a continuous process.

In the example illustrated, the mechanical closure members 18 are formed in an open-ended box pattern. The open-ended box pattern includes longitudinally extending sections 30 traversing the perforated regions 14 and laterally extending sections 32 on either side of the perforated regions 14. The open-ended box pattern may provide for rapid and consistent arrangement of the closure members 18 across the width 6 of the sleeve 4, on both sides of each perforated region 14.

Alternatively, other suitable patterns may be used for the mechanical closure members 18 in a closure region 21. For example, a zig-zag pattern of mechanical closure members 18 may be used that traverses the perforated region 14.

In the example shown, longitudinally extending sections 30 of closure members 18 extend across the perforated regions 14. Accordingly, the longitudinally extending sections 30 include closure members 18 that form part of the first plurality 20 and closure members 18 that form part of the second plurality 22 of closure members 18 adjacent the perforated region 14.

By closing the ends 26/28 of an absorbent sock 24, the mechanical closure members 18 may restrain or prevent the flow of superabsorbent polymers 12 at the ends 26 and 28 of the socks 24. In particular, the mechanical closure members 18 may substantially (or completely) prevent the flow of superabsorbent polymer 12 out of the ends 26/28 of the sock 24 once the superabsorbent polymer 12 is hydrated (and has thus expanded).

The mechanical closure members 18 can be arranged across the width 6 of the sleeve 4 to prevent the flow of superabsorbent polymer 12 substantially across the width 6 of each end 26/28 of a sock 24. The closure members 28 can be applied in a pattern configured to substantially prevent the flow of superabsorbent polymer 12 out of the ends 26/28 of the sock 24, while still permitting the socks 24 to be easily detached from the roll 2.

In some cases, some or all of the mechanical closure members 18 may extend at least partially in a direction of the width 6 of the sleeve 4. Such closure members 18 may provide a physical barrier against the flow of superabsorbent polymer 12 for the extent to which they extend along the width 6 of the sleeve 4.

In some cases, some or all of the mechanical closure members 18 may also extend at least partially in a direction of the length 8 of the sleeve 4. This may also allow some of the closure members 18 that extend across the perforated region 14 to be cut when the perforations are applied thereby facilitating the separation of the socks 24 from the roll 2.

In some examples, the mechanical closure members 18 may be stitches 19. Stitches 19 may provide lightweight and inexpensive closure members 18 that can extend through the sleeve 4. The stitches 19 can also extend through the absorbent layer(s) 10 housed within the sleeve 4.

The stitches 19 may be formed using fabrics that are tearable by a user even if they are not perforated. Thus, the socks 24 may be separated from the roll 2 even if some of the stitches 19 extending across the perforated region 14 are not perforated. In the example shown, the closure regions 21 include longitudinally extending sections 30 with stitches 19 that extend in a direction of the length 8 of the roll 2 and laterally extending sections 32 with stitches 19 that extend in a direction of the width 6.

It will be appreciated that the mechanical closure members may be made of a material that is not easily tearable. In such a case, the socks may be separated from a roll by, e.g., scissors, a box cutter or other cutting member.

Alternatively, the mechanical closure members 18 may be formed using staples. This may allow the mechanical closure members 18 to be applied rapidly, for instance using a staple gun.

Alternatively, other suitable mechanical closure members 18 may be used, such as wire sections for example.

In some embodiments, at least some of the mechanical closure members 18 provided at the first end 26 of the sock 24 can be spaced inward from the first end 26 of the sock 24. Similarly, at least some of the mechanical closure members 18 provided at the second end 28 of a sock 24 can be spaced inward from the second end 28 of the sock 24. In such an embodiment, each of the plurality of closure members 20, 22 may be individually formed on either side of the perforated region such that mechanical closure members need not be severed when a sock is separated from a roll.

Alternatively, the mechanical closure members 18 may be provided substantially at the first end 26 and/or second end 28 of the sock 24. For example, the mechanical closure members 18 may extend substantially continuously across the width 6 of the sleeve 4 at the first end 26 and second end 28 of the sock 24 (with little or no discontinuous regions).

As exemplified in FIG. 2, sock 24 has mechanical closure members 34 that are inwardly spaced from both the first end 26 and second end 28 of the sock 24. This may facilitate separation of the sock 24 from the roll 2, by spacing most of the mechanical closure members 18 away from the perforation region 14. Thus, few or no mechanical closure members 18 may need to be severed, either by the perforations 19 or by a user, to separate the sock 24 from the roll 2.

In some embodiments, the absorbent layer 10 may extend continuously throughout the longitudinal length 8 of the sleeve 4. In individual socks 24 the absorbent layer 10 may extend to the first end 26 of the sock 24 and to the second end 28 of the sock 24. Accordingly, the superabsorbent polymer 12 may also extend to the first end 26 of the sock 24 and to the second end 28 of the sock 24. This may provide for increased absorption throughout the length of the sock 24 and roll 2.

The mechanical closure members 18 can extend through the absorbent layer(s) 10 to secure the upper sleeve portion 5 and lower sleeve portion 7. Thus, the mechanical closure members 18 may substantially prevent the flow of superabsorbent polymer 12 out the ends 26/28 of the sock 24 by providing a physical barrier positioned within, and passing through, the absorbent layer(s) 10. The mechanical closure members 18 may also prevent or restrain the flow of superabsorbent polymers 12 out the ends 26/28 by closing the upper sleeve portion 5 and lower sleeve portion 7 together (even in regions where the closure members are discontinuous).

When the socks 24 include inwardly spaced mechanical closure members 34, the absorbent layer(s) 10 (and superabsorbent polymers 12) may still extend to the ends 26/28 of the sock 24. Although some of the superabsorbent polymers positioned between the inwardly spaced mechanical closure members 34 and the ends 26/28 of the sock 24 may be permitted to flow out the ends 26/28 of the sock 24, the mechanical closure members 18 can still substantially prevent the superabsorbent polymers 12 from the length of the sock 24 from flowing out the ends 26/28.

In cases where multiple socks 24 are detached from the roll 2 as a continuous length of absorbent socks 24 (i.e. multiple socks 24 are separated from the roll 2 while still attached to one another), absorbency may be improved by providing superabsorbent polymers 12 continuously along the longitudinal length 8 of absorbent socks 24.

When the socks 24 are used to absorb liquids, the superabsorbent polymers 12 may absorb and retain much of the liquid that is absorbed by the sock 24. Once the superabsorbent polymers 12 are hydrated, the mechanical closure members 18 can at least substantially prevent the flow of the superabsorbent polymers 12 out of the ends of the sock 24.

The superabsorbent polymers 12 expand as they absorb liquid. Accordingly, the mechanical closure members 18 may prevent most, if not all of the superabsorbent polymers 12 from flowing out the ends of the sock 24 even if the mechanical closure members 18 are partially discontinuous across the width 6 of the sock 24.

To manufacture a roll of absorbent socks, such as the roll 2 shown in FIG. 1 a longitudinally extending tube of liquid permeable material can be provided. The longitudinally extending tube may generally correspond to the sleeve 4 described herein above.

The longitudinally extending tube can have a superabsorbent polymer provided along the length of an interior of the tube. For example, as described herein above a substrate impregnated or seeded with superabsorbent polymer may be provided within the interior of the tub. Alternatively, the substrate may be omitted and the superabsorbent polymer particles may be disposed freely within the tube for example.

A plurality of mechanical closure members 18 can be provided at locations of the tube defining an end of a first absorbent sock and an adjacent end of a second absorbent sock. For example, tube may be fed through a manufacturing line and mechanical closure members 18 may be provided at regular intervals of the tube. These intervals may define the ends of the individual absorbent socks.

The locations of the tube defining the end of a first absorbent sock and the adjacent end of a second absorbent sock may be a single continuous region. That is, the tube may have a continuous closure region defining the end of the first absorbent sock and the end of the adjacent second absorbent sock. The plurality of mechanical closure members 18 for each location can be provided along the length of the closure region.

In some cases, the mechanical closure members may be inserted across the width of the tube at a location defining the end of the first absorbent sock and across the width of the tube at a second longitudinally spaced apart location defining the adjacent end of the second absorbent sock.

The mechanical closure members may be provided by inserting stitches, for example using a sewing machine. Alternatively, the mechanical closure members may be providing as staples using a staple gun. Various suitable alternative methods may also be used.

The mechanical closure members can be provided such that, once the superabsorbent polymer is hydrated, the mechanical closure members at least substantially prevent the flow of superabsorbent polymer out of the ends of the sock.

A plurality of perforations 16 can also be provided across the width of the tube to define the end of the first sock and the adjacent end of the second sock. The plurality of perforations 16 may be provided through the continuous closure region, or between longitudinally space apart locations defining the end of the first absorbent sock and the end of the second absorbent sock.

In some embodiments, the mechanical closure members may be providing by inserting a plurality of longitudinally spaced apart rows of stitches across the width of the tube. The plurality of longitudinally spaced apart rows of stitches may define a closure region for adjacent socks. The plurality of perforations can be provided across the closure region to separate and define the ends of the adjacent socks.

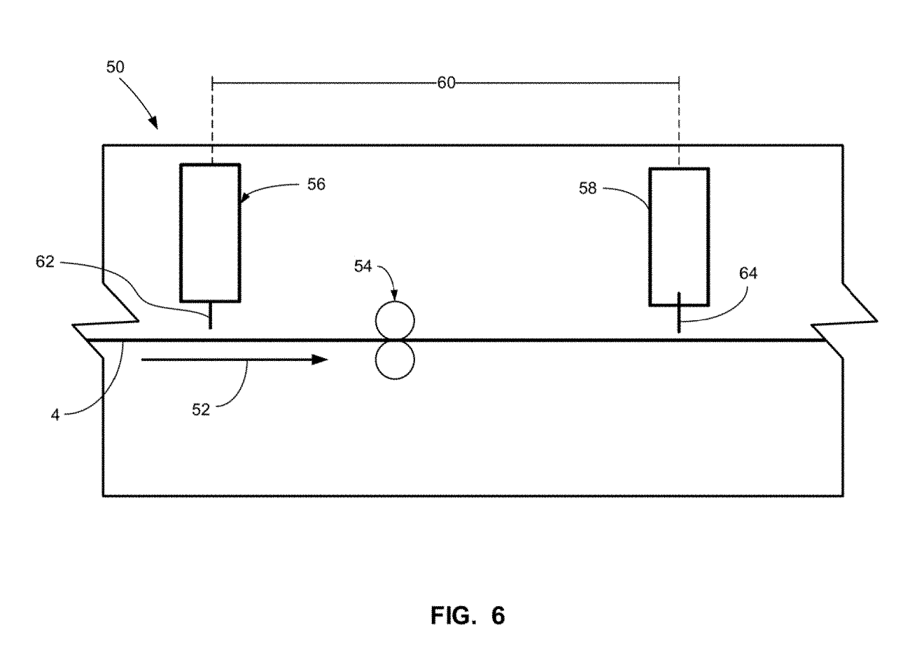

FIG. 6 is a partial schematic of an exemplary apparatus or system 50 that may be used for manufacturing a roll 2 of absorbent socks 24 in accordance with an embodiment. The system 50 illustrated in FIG. 6 may be used to manufacture a roll 2 of absorbent socks 24 such as those described herein above.

A longitudinally extending tube or sleeve 4 housing superabsorbent polymer is fed along a feed path in the direction of travel 52. For example, rollers 54 or the like may be used to convey sleeve 4 along a bed to stations at which the mechanical closure members and perforations are provided. The rollers 54 may also compress the sleeve 4 and the absorbent layer(s) 10 to flatten the roll 2 for storage. At the end of the process line, the sleeve 4 may be rolled up to form roll 2.

As illustrated in FIG. 6, the system 50 includes a closure member applicator 56. The closure member applicator 56 includes an applicator extension 62 that applies the closure members 18 to the sleeve 4. The closure member applicator 56 may be configured to apply closure members 18 to the sleeve 4 in the various configurations described herein.

For example, the closure member applicator 56 may be a sewing machine that applies stitches 19 as closure members 18. The sewing machine may be configured to apply the closure members 18 across the width of the sleeve 4 using a stitch pattern, such as an open-ended box stitch pattern or a zig-zag pattern.

It will be appreciated that portions of the sleeve 4 are not folded onto each other so as to close an end of a sock. Instead, the closure members are provided between to upper and lower ends of the sleeve 4 such that, when a sock is torn or cut off, the ends of the sleeve are only closed by the closure members 18.

The system 50 also includes a perforator 58. The perforator 58 includes one or more puncturing members 64 that operate to perforate the sleeve 4. The puncturing members 64 may include multiple puncturing members spaced apart across the width of the sleeve 4. This may allow the perforator 58 to apply perforations across the width of the sleeve 4 simultaneously. The perforations may be of any desired shape and may be spaced apart by any desired spacing.

As illustrated, the closure member applicator 56 may be positioned before the perforator 58 along the feed path of the sleeve 4. Accordingly, the closure members 18 are applied to the sleeve 4 prior to the sleeve 4 (and the absorbent layer(s) 10) being perforated. This may allow the perforator to perforate some of the closure members that traverse the perforated region, which may facilitate separation of absorbent socks 24 from a roll 2. In other embodiments, the closure member applicator 56 may be positioned after the perforator 58.

In some embodiments, the sleeve 4 may continue to be fed as one or both of the closure member applicator 56 and perforator 58 operate.

Alternatively, the sleeve 4 may be fed along the feed path in direction 52 and stopped at regular intervals. In such a case, the closure member applicator 56 and perforator 58 may be configured to operate when the sleeve 4 has stopped moving. Accordingly, when the sleeve 4 is stopped, the closure member applicator 56 may apply closure members 18 to define a closure region at one location of the sleeve 4. The perforator 58 can also perforate a longitudinally spaced apart closure region while the sleeve 4 is stopped.

To ensure that the perforator 58 applies perforations in alignment with the closure regions defined by the closure member applicator 56, the perforator 58 and closure member applicator 56 may be spaced apart along the feed path by a separation distance 60 that is an integer multiple of the regular interval between closure regions. This may facilitate simultaneous operations of the perforator 58 and closure member applicator 56 while maintaining alignment of the closure regions 21 and perforations 19. The perforator 58 and closure member applicator 56 need not be spaced apart by the separation distance 60, but rather the distance of travel of the sleeve 4 between the perforator 58 and closure member applicator 56 may correspond to the separation distance 60.

Alternatively, active alignment processes (e.g., an optical sensor) may be used to have the perforation applied such that the perforations are provided in the closure region. In some cases, a combination of active and passive alignment techniques may be used.

As used herein, the wording “and/or” is intended to represent an inclusive - or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A roll of absorbent socks, the roll comprising:
a) longitudinally extending liquid permeable sleeve having a length and a width;
b) at least one absorbent layer comprising a superabsorbent polymer housed within the sleeve;
c) a plurality of perforated regions spaced apart along the length of the sleeve, each perforated region extending across the width of the sleeve, each perforated region comprising a plurality of perforations through the sleeve and the at least one absorbent layer; and,
d) a first plurality of mechanical closure members and a second plurality of mechanical closure members longitudinally spaced apart from the first plurality of mechanical closure members and on opposed sides of and adjacent a perforated region, each plurality of mechanical closure members are provided generally across the width of the sleeve,
wherein a portion of the sleeve extending between sequential perforated regions defines a sock,
whereby, once separated along the perforated regions, each sock has a first and second longitudinally spaced apart ends that are closed by the mechanical closure members.

2. The roll of absorbent socks of claim 1 wherein the plurality of mechanical closure members comprise stitches.

3. The roll of absorbent socks of claim 1 wherein each plurality of mechanical closure members comprise rows of stitches extending generally across the width of the sleeve.

4. The roll of absorbent socks of claim 1 wherein a portion of the sleeve which defines a sock extends continuously longitudinally from a first end of the sock to a second end of the sock.

5. The roll of absorbent socks of claim 4 wherein at least some of the mechanical closure members provided at the first end of the sock are spaced inward from the first end of the sock and at least some of the mechanical closure members provided at the second end of the sock are spaced inward from the second end of the sock.

6. The roll of absorbent socks of claim 2 wherein the stitches extend in a direction of the width.

7. The roll of absorbent socks of claim 1 wherein the mechanical closure members extend through the at least one absorbent layer.

8. The roll of absorbent socks of claim 5 wherein the mechanical closure members extend through the at least one absorbent layer and the superabsorbent polymer extends to the first end of the sock and the second end of the sock.

9. The roll of absorbent socks of claim 2, wherein, once the superabsorbent polymer is hydrated, the stitches are configured to at least substantially prevent the flow of superabsorbent polymer out of the ends of the sock.

10. An absorbent sock comprising:
a) a longitudinally extending liquid permeable sleeve having a first end, a longitudinally spaced apart second end and a width, each end comprising an upper sleeve portion and a lower sleeve portion; and,
b) at least one absorbent layer comprising a superabsorbent polymer housed within the sleeve,
wherein, at each end, the upper sleeve portion and the lower sleeve portion are secured to each other by a plurality of mechanical closure members that extend through the sleeve between the upper and lower sleeve portions and which are provided generally across the width of the sleeve.

11. The absorbent sock of claim 10 wherein the mechanical closure members comprise stitches.

12. The absorbent sock of claim 10 wherein the mechanical closure members comprise rows of stitches extending generally across the width of the sleeve.

13. The absorbent sock of claim 10 wherein the sleeve extends continuously longitudinally from the first end to the second end.

14. The absorbent sock of claim 10 wherein at least some of the mechanical closure members provided at the first end are spaced inward from the first end and at least some of the mechanical closure members provided at the second end are spaced inward from the second end.

15. The absorbent sock of claim 11 wherein the stitches extend in a direction of the width.

16. The absorbent sock of claim 10 wherein the mechanical closure members extend through the at least one absorbent layer.

17. The absorbent sock of claim 10 wherein the superabsorbent polymer extends to the first end and the second end.

18. The absorbent sock of claim 11 wherein, once the superabsorbent polymer is hydrated, the stitches are configured to at least substantially prevent the flow of superabsorbent polymer out of the ends of the sock.

19. A method of manufacturing a roll of absorbent socks, the method comprising:
a) providing a longitudinally extending tube of liquid permeable material having a super absorbent polymer provided along the length of an interior of the tube;
b) providing a plurality of mechanical closure members at locations of the tube defining an end of a first absorbent sock and an adjacent end of a second absorbent sock; and
c) providing a plurality of perforations across a width of the tube to define the end of the first sock and the adjacent end of the second sock.

20. The method of claim 19 wherein the locations of the tube defining the end of the first absorbent sock and the adjacent end of the second absorbent sock comprise a single continuous region wherein step (b) comprises providing a plurality of mechanical closure members along the length of the region.

21. The method of claim 19 wherein step (b) comprises inserting stitches across the width of the tube at one location defining the end of the first absorbent sock and inserting stitches across the width of the tube at a second longitudinally spaced apart location defining the adjacent end of the second absorbent sock.

22. The method of claim 19 wherein step (b) comprises inserting a plurality of longitudinally spaced apart rows of stitches across the width of the tube to define a closure region whereby the plurality of perforations are provided across the closure region.

23. The method of claim 19 wherein, once the superabsorbent polymer is hydrated, the stitches are configured to at least substantially prevent the flow of superabsorbent polymer out of the ends of the sock.
